(19) United States
(12) Patent Application Publication
(10) Pub. No.: US 2019/0236600 A1
(43) Pub. Date: Aug. 1, 2019

(54) EFFECTING INITIATION AND AUTHORIZATION OF TRANSACTIONS BETWEEN MOBILE DEVICES

(71) Applicant: BLUECHAIN PTY LTD, Melbourne (AU)

(72) Inventor: Craig GLENDENNING, Melbourne (AU)

(21) Appl. No.: 16/341,037

(22) PCT Filed: Oct. 11, 2017
(86) PCT No.: PCT/AU2017/051099

§ 371 Date: Apr. 10, 2019

(30) Foreign Application Priority Data
Oct. 11, 2016 (AU) 2016904113

(51) Int. Cl. G06Q 20/40; G06Q 20/32; G06Q 20/22; H04W 4/80; H04B 17/318

(52) U.S. Cl. CPC G06Q 20/40; G06Q 20/3278; H04B 17/318; H04W 4/80; G06Q 20/223

(57) ABSTRACT

Some embodiments relate to a method comprising: a first mobile device detecting a radio signal and an associated authorization request packet from a second mobile device over a Bluetooth Low Energy interface, the authorization request packet including a first data attribute comprising a unique identifier of the second mobile device and a second data attribute comprising a first predetermined RSSI data value; determining a received signal strength indicator (RSSIₘ) of the detected radio signal; storing the RSSIₘ together with an associated time stamp in an historic data structure; calculating an average RSSI value, RSSI_{avg}, by performing an averaging analysis on stored RSSIₘ values in the historical data structure that are associated with the first data attribute; and if RSSI_{avg} meets or exceeds the first predetermined RSSI data value, preparing transaction data received from the second mobile device for display on an interface of the first mobile device.

### TECHNICAL FIELD

Embodiments generally relate to methods and devices configured to effect initiation and/or authorization of transactions between mobile devices using Bluetooth Low Energy.

### BACKGROUND

The use of electronic devices for making payments at point-of-sale terminals has increased significantly in recent years. Exemplary point-of-sale terminals include Near Field Communication-enabled terminals and Bluetooth-enabled terminals. It is possible for electronic devices to be used in conjunction with such terminals to enable the user of the electronic device to make a payment for the purchase of goods and services.

Within the context of payment applications, Bluetooth Low Energy (BLE) enables wireless bi-directional data transfer between devices with fast connections and ultra-low power consumption, without the requirement to pair individual devices in advance. This low power consumption compared to Classic Bluetooth is achieved by shorter stand-by times and lower peak power when transmitting data. With BLE, devices can connect, send and acknowledge data in 3 ms. As with Classic Bluetooth, BLE implements the same pairing modes: pushing content is possible but it can only be downloaded with a customer's permission.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a further method comprising:
a first mobile device detecting a radio signal and an associated authorisation request packet from a second mobile device over a Bluetooth Low Energy interface, the authorisation request packet including a first data attribute comprising a unique identifier and the second mobile device, a second data attribute comprising a first predetermined RSSI value, and a third data attribute comprising transaction data;
measuring the received signal strength indicator (RSSIₘ) of the detected radio signal;
storing the RSSIₘ together with an associated time stamp in an historic data structure;
calculating RSSI_{avg}, by performing an averaging analysis on the RSSIₘ values in the historical list which are associated with the first data attribute; and
if RSSI_{avg} meets or exceeds the first predetermined RSSI data value, preparing the transaction data for display on an interface of the first mobile device.

Some embodiments relate to a further method comprising:
a first mobile device detecting a radio signal and an associated authorisation request packet from a second mobile device over a Bluetooth Low Energy interface, the authorisation request packet including a first data attribute comprising a unique identifier of the second mobile device and a second data attribute comprising a first predetermined RSSI data value;
measuring a received signal strength indicator (RSSIₘ) of the detected radio signal;
storing the RSSIₘ together with an associated time stamp in an historic data structure;
calculating an average RSSI value, RSSI_{avg}, by performing an averaging analysis on stored RSSIₘ values in the historical data structure that are associated with the first data attribute; and
if RSSI_{avg} meets or exceeds the first predetermined RSSI data value, preparing transaction data for display on an interface of the first mobile device.

The authorisation request packet may further comprise a third data attribute comprising transaction data. The method may further comprise determining if a digital certificate, such as a payment certificate, has previously been stored to a memory of the first mobile device, and if the digital certificate has previously been stored to a memory, then the step of preparing the transaction data includes retrieving a third data attribute comprising the transaction data from the memory of the first mobile device.

The method may further comprise determining if a (digital) payment certificate has previously been stored to a memory of the first mobile device, and if the (digital) payment certificate has not previously been stored to a memory of the first mobile device, then the step of preparing the transaction data includes first downloading the (digital) payment certificate and a third data attribute comprising the transaction data from the second mobile device for storage to memory of the first mobile device.

In some embodiments, the authorisation packet may further include a second predetermined RSSI data value. The second predetermined RSSI value may be less than the first predetermined RSSI value. Each of the first and second predetermined RSSI values may be configured and set via the second mobile device. In some embodiments, if RSSI_{avg} does not meet or exceed the first predetermined RSSI data value, then the method may further include determining if RSSI_{avg} meets or exceeds the second predetermined RSSI value. If RSSI_{avg} does meet or exceed the second predetermined RSSI value, then the method may further comprise downloading a digital certificate from the second mobile device for storage to a memory of the first mobile device.

An advantage of some embodiments is that pre-emptively saving the payment certificate associated with a particular authorisation request packet can speed up the process of preparing transaction data for display in the future, when the mobile device meets the requisite criteria for display.

The stored RSSIₘ values used in the averaging analysis may each have a time stamp not older than a predetermined age, Ageₘₐₓ. The predetermined age may be an age selected from a time period between about 0.1 seconds and about 5 seconds, optionally between about 0.2 seconds and about 2 seconds.

The method may further comprise:
receiving a plurality of subsequent data packets from the second mobile device, each subsequent data packet being received at the first mobile device after receiving the authorisation request packet, and each subsequent data packet including the first and second attributes;
determining a received signal strength indicator (RSSIₘ) of the detected radio signal of each received subsequent data packet;
storing the RSSIₘ of each received subsequent data packet together with an associated time stamp of receipt of the respective subsequent data packet in the historic data structure.

If RSSI_{avg} does not meet or exceed the first predetermined RSSI data value, then the calculating may be performed again after a predetermined delay. The predetermined delay may be between about 2 seconds and about 5 seconds, for example. The number of stored RSSIₘ values used in the calculating may be between 2 and 100, optionally between 2 and 50, optionally between 10 and 20, for example.

Some embodiments relate to a mobile device comprising:
a transceiver unit configured to detect a radio signal and an associated authorisation request packet from a second mobile device over a Bluetooth Low Energy air interface, the initiation packet including a unique first data attribute comprising a unique identifier of the second mobile device and a second data attribute comprising a first predetermined RSSI data value;
a processor in communication with the transceiver unit;
a data structure stored in a memory accessible to the processor;
logic stored in the memory and executable by the processor to:
   determine a received signal strength indicator (RSSIₘ) of the detected radio signal;
   store the RSSIₘ together with an associated time stamp in an historic data structure;
   calculate an average RSSI value, RSSI_{avg}, by performing an averaging analysis on stored RSSIₘ values in the historical data structure that are associated with the first data attribute; and
   if RSSI_{avg} meets or exceeds the first predetermined RSSI data value, prepare transaction data received from the second mobile device for display on an interface of the first mobile device.

Some embodiments relate to a method comprising:
a first mobile device receiving a first packet from a second mobile device over a Bluetooth Low Energy air interface, the first packet including a unique first data attribute and a second data attribute;
assessing if information corresponding to the first and second data attributes have previously been stored to a data structure;
storing information corresponding to the first and second data attributes in a data structure if said attributes have not previously been stored, and if said attributes have been previously stored, determining if the stored information requires reordering.

In some embodiments, the first data attribute is a unique name or unique identifier of the second mobile device and the second data attribute is a payment certificate or a digital certificate associated with the second mobile device. The payment certificate or digital certificate may be associated with a digital representation (stored in the second mobile device) of a transaction account, an example of which may be referred to as an eCard.

In some embodiments, if it is determined that the stored information requires reordering, then reordering the stored information based on a list of most frequently detected attributes.

Some embodiments relate to a mobile device comprising:
a transceiver unit configured to receive a packet from another mobile device over a Bluetooth Low Energy air interface, the packet including a unique first data attribute and a second data attribute;
a processor coupled to the transceiver unit;
a data structure coupled to the processor;
logic to:
   i) determine if information corresponding to the first and second data attributes have previously been stored to the data structure;
   ii) store information corresponding to the first and second data attributes in the data structure if said attributes have not previously been stored, and
   iii) if said attributes have been previously stored, determining if the stored information requires reordering.

Some embodiments relate to a mobile device comprising:
a transceiver unit configured to receive a packet from another mobile device over a Bluetooth Low Energy air interface, the packet including a unique first data attribute and a second data attribute;
a processor in communication with the transceiver unit;
a data structure stored in a memory accessible to the processor;
logic stored in the memory and executable by the processor to:
   i) determine if information corresponding to the first and second data attributes have previously been stored to the data structure,
   ii) store information corresponding to the first and second data attributes in the data structure if said attributes have not previously been stored, and
   iii) if said attributes have been previously stored, determine if the stored information requires reordering.

Some embodiments relate to computer readable storage storing processor-executable program instructions that, when executed by a processor of a mobile device, cause the mobile device to perform any of the methods broadly described above. The computer readable storage may comprise a tangible memory device, either portable, such as a hand-held thumb drive, or incorporated within memory of a computing device or system.

### BRIEF DESCRIPTION OF DRAWINGS

Embodiments are described in further detail below, by way of example, and with reference to the accompanying drawings, in which:

FIG. 1 is a schematic plan view of a first embodiment of a mobile device configured in accordance with some embodiments;

FIG. 2 is a flow diagram illustrating an example implementation of a method according to some embodiments;

FIG. 3 is a flow diagram depicting a method of operation of the mobile device shown in FIG. 1, according to some embodiments.

### DETAILED DESCRIPTION

Various embodiments are described in detail herein with reference to the accompanying drawings. Wherever possible, the same reference numbers will be used throughout the drawings to refer to the same or like parts. References made to particular examples and implementations are for illustrative purposes, and are not intended to limit the scope of the present disclosure.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C (112), paragraph six, interpretation for that unit/circuit/component.

The term “mobile device” is used herein to refer to any form of mobile computing and communication device that may be carried by a person, such as a smartphone, tablet computer, smartwatch, laptop computer and the like that include communication circuitry and a processor configured to perform the operations of the various embodiments.

The term “peripheral mobile device” is used herein, when used within the context of the Bluetooth Low Energy protocol, to refer to a mobile device as indicated in the preceding paragraph, that broadcasts or advertises its presence. A peripheral mobile device may be referred to as a merchant or merchant device. In some instances, the peripheral mobile device may also be described as an initiating device since it may the device that initiates a transaction with a responding device, such as a customer mobile device.

The term “customer mobile device” is used herein, when used within the context of the Bluetooth Low Energy protocol, to refer to a mobile device as indicated in the preceding paragraph, that listens for peripheral mobile devices and initiates a connection with peripheral mobile devices. A customer mobile device may be referred to as a consumer or a “consumer device”, a “customer device” or a responding device, where it does not initiate a transaction. In embodiments described herein, a mobile device may be configured to operate as a customer device for certain transactions and may operate in an alternative configuration as a peripheral mobile device in other transactions. The operational mode of the mobile device may be transaction-specific and may depend on dynamic inputs or default settings. For example, such default settings can include default operational parameters set in an application (e.g. software application 155) executing on the mobile device, and dynamic inputs may include user input received (e.g. via the application 155) by the mobile device to indicate a desire to initiate a transaction.

The term “transaction data” is used herein to refer to data indicative of a possible transaction event, including a putative or proposed (but not yet completed) transaction. Further, such a transaction event does not have to be a financial transaction event and does not necessarily require the presence of payment data. Such transaction data may include one or more of a numerical value, line item(s), one or more objects often referred to as references and a time dimension (i.e. time stamp). Such references may include a receipt number or business number, for example.

At present, at least all iPhones from 4S and up support BLE peripheral mode and Android L-release devices typically also support BLE peripheral mode. Accordingly, such smartphones may therefore be configured as a BLE peripheral mobile device that is broadcasting signals, where the customer computing device receives the signals from the peripheral (mobile) computing device and is able to establish a connection with the peripheral (mobile) computing device broadcasting a specific Service Universal Unique Identifier (UUID).

BLE is a technology that transmits information at a frequency of about 2.4 GHz (about 2042-2480 MHz) over forty (40) 2-MHz wide channels, and has a range of about 50 meters. Information transmitted according to the BLE protocol may be transmitted at a rate of about 1 Mbit/s with an application throughput of about 0.27 Mbit/s. In some embodiments, BLE communications may be secured using 128-bit Advanced Encryption Standard (AES) encryption with counter mode with a cipher block chaining message authentication code (CBC-MAC) and user defined security. Further, in some embodiments, BLE communications may utilize adaptive frequency hopping, lazy acknowledgement, a 24-bit cyclic redundancy check (CRC) and 32-bit message integrity check for robustness.

In some embodiments, mobile device interactions may be detected and/or reported for a user by the user's mobile communication mobile device that are in proximity of another mobile device advertising a payment service via a communication network. Such a communication network is supported using Bluetooth Low Energy and may also be supported using WiFi, Classic Bluetooth, and possibly another wireless communication protocol.

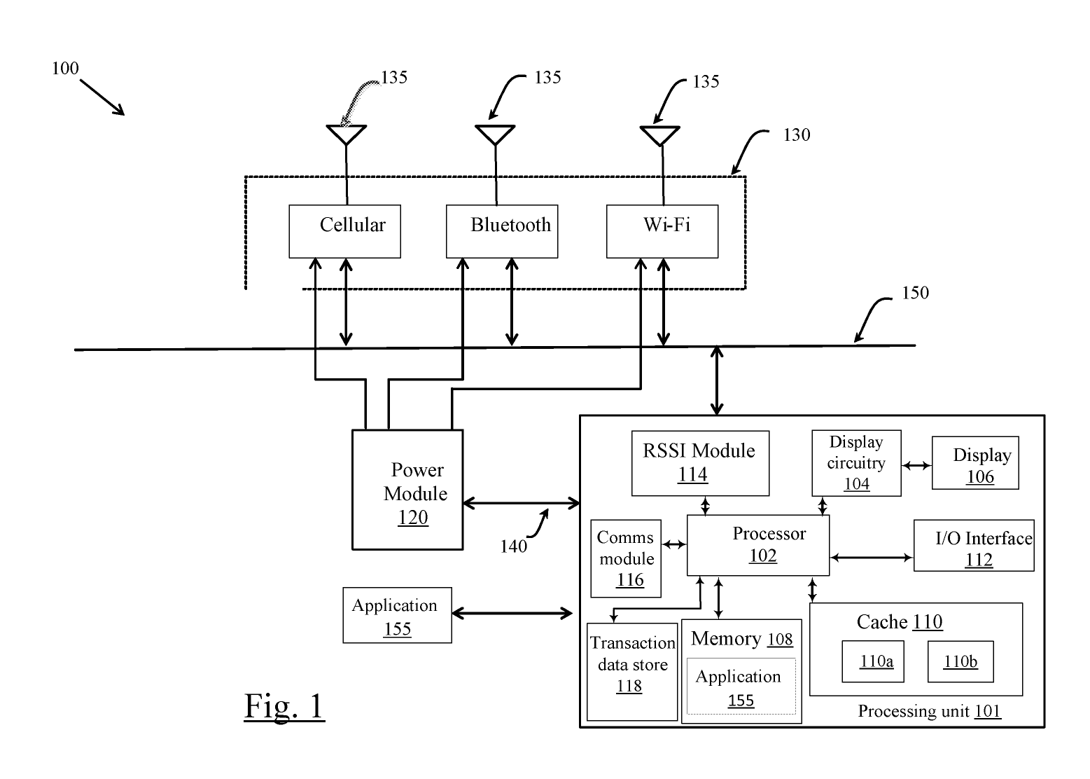

FIG. 1 is a simplified functional block diagram of an embodiment of a mobile device 100 that is referred to throughout this description. Mobile device 100 comprises a processing unit 101 and a transceiver unit 130, both of which are powered by a power module 120. The transceiver unit 130 includes transceiver circuitry for wireless communications, such as a personal area network (PAN) transceiver for Bluetooth-enabled communications, a wireless local area network (WLAN) transceiver for WiFi-enabled communications, and optionally a mobile telephony transceiver for mobile telephony and data communications. Transceiver unit 130 may have incorporated therein or electronically coupled thereto a specific antenna 135 for each separate wireless signal transceiver.

Mobile device 100 includes a processor 102 which is coupled to display circuitry 104, which in turn is coupled to display 106. Display 106 may include a touch screen display, the functions of which are executed by display circuitry 104, for example. The processor 102 is also coupled to a general purpose memory 108, a fast-access data structure, for example in the form of a cache memory 110, and a transaction data store 118. The mobile device 100 also includes an I/O interface 112 that is coupled to the processor 102, and may be used for coupling the mobile device 100 to a computer system, or other external device. The processor 102 is further coupled to an RSSI module 114, a communications module in the form of a Bluetooth low energy module 116, a power control module 120, a transceiver unit 130, and antennas 135. For other embodiments, memory 108 and/or RSSI monitoring module 114 and/or Bluetooth low energy module 116 and/or cache 110 can be formed separately from processor 102. Power control module 120 provides power to the various described components of the mobile device 100, either directly or in response to control signals from the processor 102.

The processor 102, memory 108, display circuitry 104, display 106, cache 110, I/O interface 112, RSSI module 114, communications module 116 and transaction data store 118 may form part of a processing unit 101. In some embodiments, the processing unit 101 may be separate from components that do not strictly involve data processing, such as the display 106. The processing unit 101 may be responsible for primary data processing and software execution functions of the mobile device 100, including interacting with transceiver unit 130 to receive and transmit data from and to external devices.

Memory 108 can be or comprise any suitable volatile or non-volatile (persistent) memory element or device including, for example, random access memory (RAM), read-only memory (ROM), a Dynamic RAM (DRAM), a Synchronous DRAM (SD-RAM), electronically erasable programmable read-only memory (EEPROM) or Flash memory.

Processor 102 can be or comprise any suitable processor capable of executing scripts or instructions of one or more code modules or software programs stored, for example, in memory 108. The processor 102 may be representative of a number of different types of processors that may be found in a wireless communications device. For example, processor 102 may include a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. The processor 102 may include baseband processing and therefore may digitally process the signals received by the transceiver unit 130 and may further process data to be transmitted by the transceiver unit 130.

Processor 102 is coupled to power module 120 by a signal connection 140, for example including signal conductors, and is coupled to transceiver unit 130 by a common data bus 150. For other embodiments, common data bus 150 can be omitted, and processor 102 can transmit and receive data from elements of transceiver unit 130 via dedicated signal connections. RSSI monitoring module 114 can be implemented using software, hardware, or a suitable combination thereof. In accordance with the present embodiments, RSSI monitoring module 114 monitors signals broadcast from a central monitoring device and measures the RSSI values of these signals according to existing techniques.

The data structure in the form of or comprised in cache memory 110 is a fast storage device that stores frequently used data. The data structure may be embodied as one or more databases, tables, text files, linked lists, or other desired data structure and stored in a computer-readable medium accessible to the processor 102.

Processor 102 communicates with application 155 which is installed on the mobile device 100. The application 155 facilitates the exchange of characteristic information. The application 155 may be stored as executable program code in the memory 108 and is executable by processor 102 to function as one of a number of executing software applications instantiated on the mobile device 100. The application 155 may be programmed to provide a user interface for facilitating initiation of a transaction and a response to such an initiation from another device.

In this embodiment, cache memory 110 includes a long term cache 110a and a short-term, frequently used cache 110b. Both the short term and the long-term cache includes a plurality of data storage blocks configured to receive and store data attributes. Data attributes can be static attributes or dynamic attributes. The short-term cache 110b is configured to store data relating to the most frequently detected data attributes. The short-term cache is modified and is refreshed by processor 102 to stay current as a user's location and habits change.

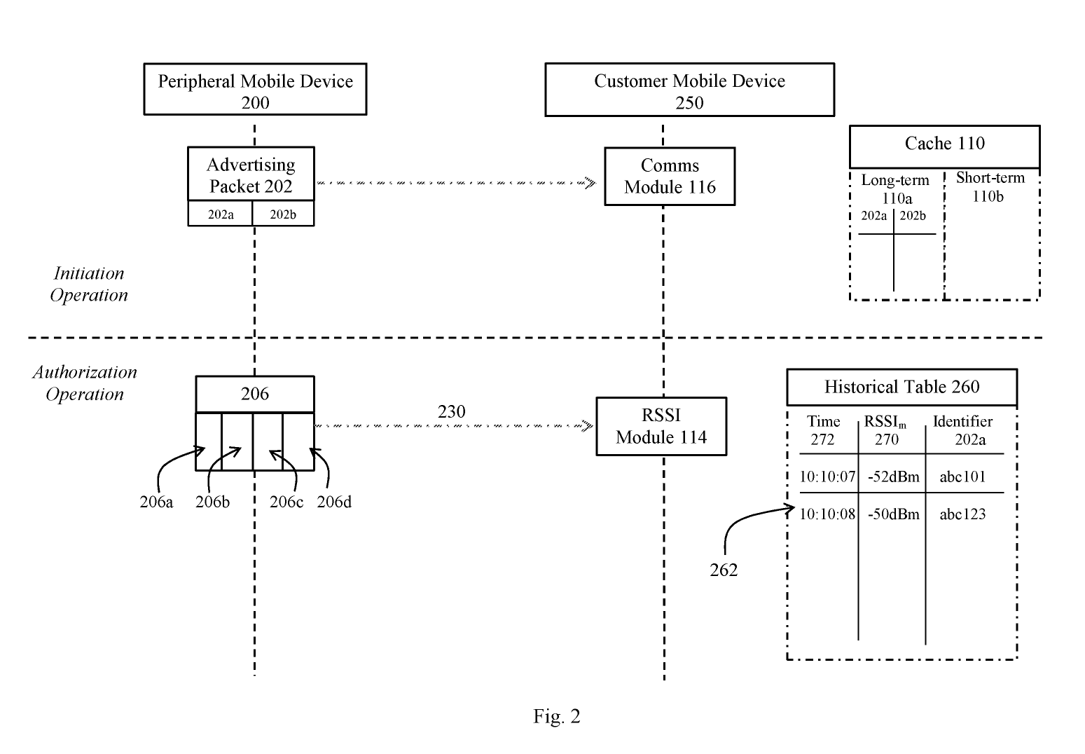

As described further below in conjunction with the drawings shown in FIG. 2, a first mobile device 100 is or may be configured as a peripheral mobile device 200 (a merchant) and a second mobile device 100 is or may be operating in a payment request receive mode as a customer mobile device 250 (a consumer). In various embodiments, the peripheral mobile device 200 broadcasts a data packet 202 at a predetermined interval using the Bluetooth LE protocol. The predetermined interval may be much less than a second, for example less than 0.4, 0.3, 0.2 or 0.1 seconds. For example, the predetermined interval may be small fractions of a second, such as tens of microseconds or less than ten microseconds, and optionally between 2 to 5 microseconds, for example. The broadcast data packet 202 may be encoded as a merchant/advertiser identifier packet. The advertiser identifier packet 202 includes at least merchant certificate data 202a, such as a universal unique identifier (UUID), that identifies the particular device belonging to the merchant. The data packet 202 further includes a payment certificate 202b that will be needed in the event that a payment transaction occurs that is associated with this particular merchant.

In some embodiments, the peripheral mobile device 200 may act as a server, and the customer mobile device 250 may act as a client in a client-server arrangement. More particularly, in such an embodiment, the advertiser identifier broadcast of packets 202 may not be continuous, but rather when prompted by particular application software, or when activated by user interaction with a software application on a nearby electronic device. For example, a shop assistant may operate a cash-register emulating (transaction processing) software application executing on an electronic device, such as a tablet computing device for example, that interacts with a related or cooperative application 155 on the peripheral mobile device 200 to cause the advertising packet 202 to be transmitted locally using the BLE protocol. Alternatively, the peripheral mobile device 200 may be the electronic device that executes the cash-register emulating (transaction processing) software application and that also executes the cooperative application 155 to cause the advertising packet 202 to be transmitted locally using the BLE protocol.

As depicted in FIG. 2, the transmission by the peripheral mobile device 200 of the advertising data packet 202 and the first receipt of the advertising data packet 202 at the communications module 116 of the customer mobile device 250 effectively forms an initiation operation for effecting a transaction. An authorization operation then commences, as described below.

Either way, the communications module 116 of the customer mobile device 250 is configured to continuously scan for broadcasts in its vicinity using a Bluetooth LE protocol. In one embodiment, when the communications module 116 of the customer mobile device 250 detects a broadcast packet in its vicinity, the customer mobile device's processor 102 looks up the long-term cache 110a to determine if the peripheral mobile device 200 has previously been discovered. If the device has not previously been discovered then the processor 102 writes data relating to static attributes of the received broadcast packet to the long-term cache 110a. A first attribute relates to the unique name or unique identity 202a of the peripheral mobile device 200 and a second attribute relates to the advertiser's payment certificate 202b (i.e. a payment certificate associated with and provided by one or more peripheral mobile devices 250 associated with the same merchant identity). These attributes are considered static, since they do not frequently change once they are assigned to the device 200 or the merchant possessing the device 200.

Advertising packet 202 further comprises a first predetermined RSSI value, which may not change regularly for a given peripheral mobile device 200 but may be configurable at the peripheral device 200 is therefore dynamic rather than static. For example, the first predetermined RSSI value may be configurable at the peripheral device 200 via application 155. The first predetermined RSSI value may be in the range of −50 dBm to about −90 dBm, for example such as −50 dBm, −55 dBm, −60 dBm, −65 dBm, −70 dBm, −75 dBm, −80 dBm, −85 dBm and −90 dBm and values in between. The second predetermined RSSI value is lower than the first predetermined RSSI value and may be less than −90 dBm, less than about −95 dBm or less than 100 dBm, for example. In some embodiments, the second predetermined RSSI value may be any RSSI value that is detectable by the Bluetooth transceiver of the customer mobile device 250 and that is less than the first predetermined RSSI value.

In some embodiments, 202a represents a first data component of the advertising packet 202 that comprises two data attributes: the UUID 206a of the peripheral mobile device 200; and the predetermined RSSI value 206b to be used to determine whether to display the transaction data. In such embodiments, 202b represents a data component of the advertising packet 202 that comprises two data attributes: a digital certificate 206c of the peripheral mobile device 200; and transaction data 206d pertaining to a transaction to be conducted between the peripheral mobile device 200 and the customer mobile device 250.

If the customer mobile device's processor 102 determines from data stored in cache 110a that the peripheral mobile device 200 has previously been discovered, for example by determining that an entry 262 already exists in the historical table 260 for that peripheral mobile device 200, then the processor 102 of customer mobile device 250 utilises a most frequently detected algorithm or executes a relevance determination process to determine if entries in the short term cache 110b need to be re-ranked, for example as a result of detection of the most recently detected peripheral mobile device 200. This allows certificates that are not frequently used to be culled from the memory of device 250. Without such a culling process, the number of different certificates stored in the memory 108 or cache 110 of the customer mobile device 250 can become significant over time, causing a higher processing burden for processor 102 and slowing down device functions for the customer mobile device 250.

In particular, the processor 102 determines the relevance of the most recently detected peripheral mobile device 200 by employing logic accessible from memory 108 that is configured to analyse and validate the unique identity of the peripheral mobile devices 200 and generate a relevance score for each peripheral mobile device 200 from which a broadcast packet is received. For example, during the current search or relevance determination, if the unique identity of a peripheral mobile device 200 matches the unique identity from a previously discovered mobile device, its relevance score would increase. Furthermore, since this mobile device 200 had been previously discovered, the current search could avoid performing the additional step of downloading attributes of the device 200, such as its digital certificate, because those steps were performed during a previous search. Consequentially, the efficiency of the initiation process is improved. Efficiency improvements in such circumstances may be in the order of a few seconds. This may seem like a small efficiency gain, but delays of a few seconds can seem significant and annoying for busy people who are used to their electronic transactions being processed seemingly instantly. Such delays can be compounded for busy establishments that frequently experience customers queuing to complete a purchase transaction.

Meanwhile, the peripheral mobile device 200 additionally broadcasts packets 206 (subsequent to the initially detected advertising packet 202) at a (short) predetermined interval using the BLE (RSSI) protocol. For example, the peripheral mobile device 200 may transmit subsequent broadcast packets 206 at a rate of several hundred per second. In some instances, the rate of broadcast may be lower, such as 2 to 100 times, optionally in the range of 2 to 50 times, further optionally in the range of 10 to 20 times. The packets 206 may be encoded as advertisement packets which include a number of attributes which may be static and/or dynamic. The attributes include: the unique name or unique identity 206a of the device 200 (such as the device's UUID), a minimum to Query data value (Queryₘᵢₙ) 206b, a minimum to display data value (Displayₘᵢₙ) 206c and transaction data 206d. The “minimum to query” data value is the second predetermined RSSI value, above which the customer mobile device 250 will seek to pre-load the digital certificate 206c of the peripheral mobile device 200. The “minimum to display” data value is the first predetermined RSSI value, above which the customer mobile device 250 will seek to load transaction data from the peripheral mobile device 200 and to load the digital certificate 206c of the peripheral mobile device 200 if it is not already stored in cache 110.

The merchant or other user of peripheral mobile device 200 is able to adjust the values of each of the variables Queryₘᵢₙ and Displayₘᵢₙ to suit the particular situation, for example using application 155. For example, different establishments may set the first predetermined RSSI value to correspond with a shorter or larger distance from the checkout counter (or other position) where the peripheral mobile device 200 is located, based on the nature of the business of the establishment and/or the likely location and/or density of customers in the establishment.

The customer's mobile device's RSSI module 114 monitors for RSSI signal broadcasts 230 of advertising packet 202 and packets 206 transmitted subsequently to the advertising packet 202 and once detected, the RSSI module 114 measures the strength of the RSSI signal (RSSIₘ) associated with a received broadcast packet 202, 206. Attributes including the RSSIₘ 270 and a time stamp 272 at which the signal was measured are then written as an entry 262 to an historical table 260 in memory 108. The entry 262 further includes the unique name or unique identity UUID of the transmitting device 202a.

The customer's mobile device's RSSI module 114 in conjunction with processor 102 performs an averaging analysis algorithm (by executing code stored in memory 108) using a number of variables that have been stored to memory 108. The variables include (i) a maximum age, Ageₘₐₓ of an historical data packet, (ii) a minimum age, Ageₘᵢₙ of an historical data packet, a minimum number of packets, Packetₘᵢₙ, and a maximum number of packets, Packetₘₐₓ. The Ageₘᵢₙ is utilised to minimise the likelihood that the central device is moving towards or away from the peripheral device (for instance a time of the order of 2.5 seconds, optionally in the range of about 0.5 seconds to about 5 seconds, optionally between about 1.0 to about 2.5 seconds). Packetₘᵢₙ sets the minimum number of historical data packets (stored in cache 110b) required to carry out the averaging analysis algorithm, to ensure that short term fluctuations are partially smoothed. Packetₘₐₓ sets the maximum number of historical data packets (stored in cache 110b) to include in the averaging analysis algorithm, to ensure that the process is not swamped with information.

Because of the high speed with which the BLE protocol allows a peripheral mobile device 200 to transmit packets 202 and 206, the historical table data structure 260 of a nearby customer mobile device 250 can potentially receive and store several hundred entries in a matter of a couple of seconds. Thus, the term historical as used herein is to be understood to only relate to a very short period of time, such as a few seconds, not days, weeks or months.

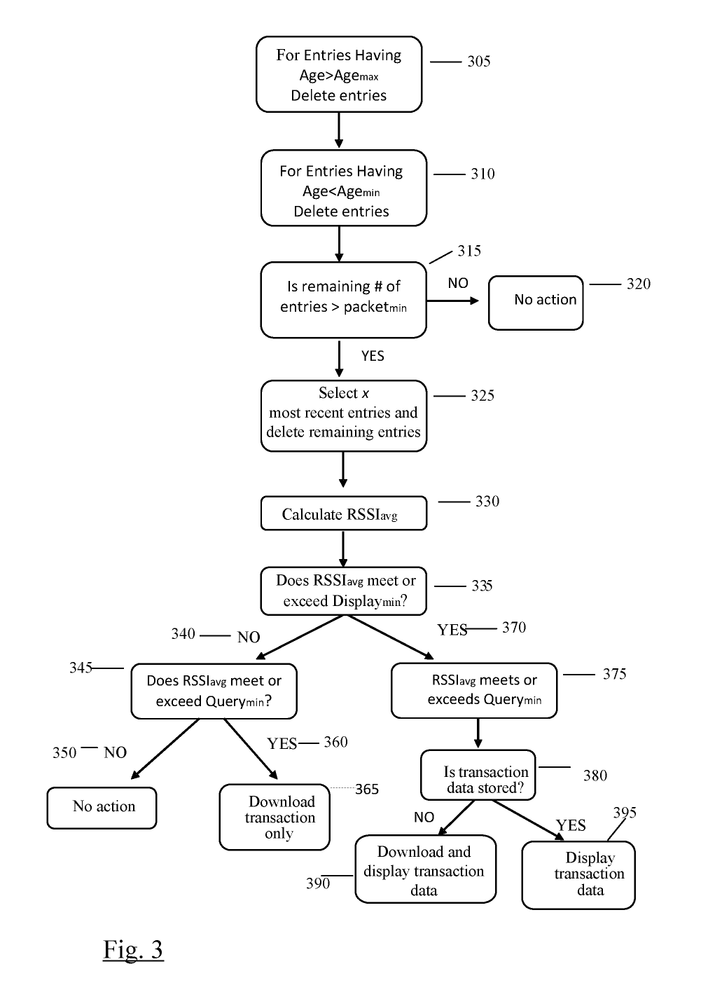

Referring now to FIG. 3, there is shown a flowchart of a process of performing an averaging analysis during operation of a customer mobile device 250. First, a data culling sub-process is performed. Using the time stamp 272, entries in the historical table 260 are culled to remove those entries which exceed Ageₘₐₓ (step 305) and those entries which fall short of Ageₘᵢₙ (step 310). Either Ageₘₐₓ or Ageₘᵢₙ can be initially checked. Ageₘₐₓ may be set in the range of 2 to 5 seconds, for example. Note that only entries in the historical table 260 relating to or associated with the particular identifier 202a are used. The remaining entries in the historical table relevant to that identifier 202a are counted to ensure that the number of entries for received broadcast packets 206 exceeds Packetₘᵢₙ (step 315). If the number of historical data entries in table 260 for received broadcast packets 206 does not exceed Packetₘᵢₙ, then the process stops (step 320). If the number of historical data entries in table 260 for received broadcast packets 206 does exceed Packetₘᵢₙ, then a predetermined number (e.g. 20 to 100, 20 to 80, 20 to 60 or 30 to 50) of most recent entries are selected, and those entries that are not selected are deleted (step 325). From the selected (non-deleted) RSSIₘ entries, the average RSSIₘ value (RSSI_{avg}) is then determined (step 330). The averaging analysis process described above for calculation of RSSI_{avg} may be repeatedly performed a number of times, at (optionally user configurable) a predetermined time interval while the customer mobile device 250 is in a range between the first predetermined RSSI value and the second predetermined RSSI value. The predetermined interval may be a time period similar or slightly greater than Ageₘₐₓ, such as from about 2 seconds to about 5 seconds long, for example.

The value of RSSI_{avg} is then compared against the Display data value (Displayₘᵢₙ) 206c (step 335). If the value of RSSI_{avg} does not meet or exceed Displayₘᵢₙ (step 340) the value of RSSI_{avg} is then compared against the minimum to Query data value (Queryₘᵢₙ) 206b (step 345). If the value of RSSI_{avg} does not meet or exceed Queryₘᵢₙ (step 350), then the process stops.

Reverting back to step 345, if the value of RSSI_{avg} does exceed Queryₘᵢₙ (step 360), then it is anticipated that the consumer is not in the immediate vicinity of peripheral mobile device 200 to be engaged in the making of a transaction, therefore the transaction data is not displayed on the interface of the customer mobile device 250. Instead, the transaction data is downloaded (step 365) either via the Bluetooth BLE interface or by calling a central server and is passed to the application 155 for processing. The application 155 validates the transaction data using the digital payment certificate 202b (if present) and stores the transaction data and result within the transaction data store 118 and references the transaction data against the identifier 202a. The advantage of downloading the data is that there is a likelihood that the customer's mobile device 250 will come into the immediate vicinity of peripheral mobile device 200 in order to engage in a transaction again. In the event that this occurs, the transaction data is more readily accessible, having already been validated and stored to the transaction data store 118 of the customer mobile device 250 and the customer mobile device 250 need merely retrieve the transaction data for display on the mobile phone's display 106. Accordingly, the transaction data remains in the transaction data store 118 until the processor advises or determines that the appropriate RSSI_{avg} has been achieved and thus the data can be displayed or until the transaction is deleted from memory.

Reverting back to step 335, if the value of RSSI_{avg} does exceed Displayₘᵢₙ (step 370), then it is assumed that the value of RSSI_{avg} meets or exceeds Queryₘᵢₙ (step 375). The memory (transaction data store 118) is checked to determine if the transaction data for this advertisement packet 202 has previously been downloaded (step 380). If the transaction data is stored to memory in cache 110a or transaction data store 118, then the transaction data is retrieved from that memory for display on the interface of the customer mobile device 250 (step 385). If the transaction data is not stored to memory (for instance if this is the first time that the customer mobile device 250 has detected the advertisement broadcast), then the payment certificate and transaction data is downloaded and stored in cache memory 110a, referenced against the identifier 202a and also displayed on the interface of the customer mobile device 250 (step 390).

In instances where the transaction data is prepared for display on the interface of the customer mobile device 250, the customer mobile device's processor 102 first verifies and validates the associated merchant payment certificate 202b, which has been stored in the cache 110. On validating the payment certificate 202b, the customer device's processor 102 will validate that the transaction data has come from the merchant and has not been modified of changed, and if valid will display the payment request on the customer's mobile device's display 106, including an interface for authorisation (e.g. via transaction facilitation application 155). This process is significantly streamlined since the merchant's certificate data has already be obtained and is stored in the cache 110a of the customer mobile device 250.

If the consumer accepts the payment request, then the consumer's mobile device 250 generates an authorisation request message and passes the message back to the peripheral device 200. The peripheral device 200 receives the authorisation request message and forwards it via traditional networking means onto a server system, otherwise referred to as a payment server, which resides in a Payment Card Industry-data security standard (PCI-DSS) compliant environment. The server system includes one or more processors, memory storage and communication interfaces to interface wirelessly (and using common wired data networks) with peripheral and customer mobile devices 200 and 250.

As a result of the consumer authorising the payment request, the long term cache 110a is updated to include the identity of the merchant 202a and the payment certificate of the merchant 202b. The peripheral mobile device 200 then updates a series of characteristics that indicate to the consumer the progress of the transaction. The consumer mobile device 250 polls these progress characteristics on the merchant's device 200 until an end state is reached, i.e. the transaction was successful or an error state was reached. The resulting end state is displayed on an interface of the customer's mobile device 250, which may be generated by application 155 as executed by processor 102, for example.

Transmission of transaction data as described herein may be performed in accordance with the methodology as described in co-owned PCT/AU2011/000055, the contents of which are entirely incorporated by reference herein.

Numerous variations and/or modifications may be made to the above-described embodiments, without departing from the broad general scope of the present disclosure. For instance, in relation to FIG. 2, the first mobile device was described as being configured as a peripheral mobile device 200 (a merchant) and the second mobile device was described as being configured as a customer mobile device 250 (a consumer). With reference to FIG. 1, the mobile device 100 is able to be selectively configurable to function in one instance as a merchant mobile device 200 and in another instance as a consumer mobile device 250.

In some embodiments, an application 155 (or paired complementary versions thereof) may be installed on the peripheral mobile device 200 and the customer mobile device 250 to facilitate the exchange of characteristic information for carrying out a transaction. The application 155 on the respective mobile devices are configured to communicate information to a payment service gateway, for example such as a payment gateway known as the Bluechain™ Payment Gateway.

Various values, functions, features, systems and embodiments described herein can be modified to suit a particular environment. The presently described embodiments are, therefore, to be considered in all respects as illustrative and not restrictive.

1. A method comprising:
a first mobile device detecting a radio signal and an associated authorisation packet from a second mobile device over a Bluetooth Low Energy interface, the authorisation packet including a first data attribute comprising a unique identifier of the second mobile device, a second data attribute being a first predetermined RSSI data value, and a third data attribute comprising transaction data;
measuring the received signal strength indicator (RSSIₘ) of the detected radio signal;
storing the RSSIₘ together with an associated time stamp in an historic data structure;
calculating RSSI_{avg} by performing an averaging analysis on the RSSIₘ values in the historical list which are associated with the first data attribute; and
if RSSI_{avg} meets or exceeds the first predetermined RSSI data value, preparing the transaction data for display on an interface of the first mobile device.

2. A method comprising:
a first mobile device detecting a radio signal and an associated authorisation request packet from a second mobile device over a Bluetooth Low Energy interface, the authorisation request packet including a first data attribute comprising a unique identifier of the second mobile device and a second data attribute comprising a first predetermined RSSI data value;
determining a received signal strength indicator (RSSIₘ) of the detected radio signal;
storing the RSSIₘ together with an associated time stamp in an historic data structure;
calculating an average RSSI value, RSSI_{avg}, by performing an averaging analysis on stored RSSIₘ values in the historical data structure that are associated with the first data attribute; and
if RSSI_{avg} meets or exceeds the first predetermined RSSI data value, preparing transaction data received from the second mobile device for display on an interface of the first mobile device.

3. The method of claim 2, wherein the authorisation request packet comprises the transaction data.

4. The method of claim 2, wherein the transaction data is received separately from the authorisation request packet.

5. The method of claim 2, further comprising determining if a payment certificate has previously been stored to a memory of the first mobile device, and if the payment certificate has previously been stored to a memory then the step of preparing the transaction data includes retrieving the transaction data from the memory of the first mobile device.

6. The method of claim 2, further comprising determining if a payment certificate has previously been stored to a memory of the first mobile device, and if the payment certificate has not previously been stored to a memory of the first mobile device then the step of preparing the transaction data includes first downloading the payment certificate and the third attribute from the second mobile device for storage to memory of the first mobile device.

7. The method of claim 2, where the authorisation packet further includes a second predetermined RSSI data value.

8. The method of claim 7, wherein if RSSI_{avg} does not meet or exceed the first predetermined RSSI data value, determining if RSSI_{avg} meets or exceeds the second predetermined RSSI value.

9. The method of claim 8, wherein if RSSI_{avg} does meet or exceed the second predetermined RSSI value, downloading a digital certificate of the second mobile device for storage to memory of the first mobile device.

10. The method of claim 7, wherein the second predetermined RSSI value is less than the first predetermined RSSI value.

11. The method of claim 7, wherein each of the first and second predetermined RSSI values is configurable via the second mobile device.

12. The method of claim 2, wherein the stored RSSIₘ values used in the averaging analysis each have a time stamp not older than a predetermined age.

13. The method of claim 12, wherein the predetermined age is between about 0.1 seconds and about 5 seconds.

14. The method of claim 13, wherein the predetermined age is between about 0.2 seconds and about 2 seconds.

15. The method of claim 2, further comprising:
receiving a plurality of subsequent data packets from the second mobile device, each subsequent data packet being received at the first mobile device after receiving the authorisation request packet, and each subsequent data packet including the first and second attributes;
determining a received signal strength indicator (RSSIₘ) of the detected radio signal of each received subsequent data packet;
storing the RSSIₘ of each received subsequent data packet together with an associated time stamp of receipt of the respective subsequent data packet in the historic data structure.

16. The method of claim 2, wherein if RSSI_{avg} does not meet or exceed the first predetermined RSSI data value, then the calculating is performed again after a predetermined delay.

17. The method of claim 16, wherein the predetermined delay is between about 2 seconds and about 5 seconds.

18. The method of claim 2, wherein the number of stored RSSIₘ values used in the calculating is between 2 and 50.

19. A mobile device comprising:
a transceiver unit configured to detect a radio signal and an associated authorisation request packet from a second mobile device over a Bluetooth Low Energy air interface, the initiation packet including a unique first data attribute comprising a unique identifier of the second mobile device and a second data attribute comprising a first predetermined RSSI data value;
a processor in communication with the transceiver unit;
a data structure stored in a memory accessible to the processor;
logic stored in the memory and executable by the processor to:
determine a received signal strength indicator (RSSIₘ) of the detected radio signal;
store the RSSIₘ together with an associated time stamp in an historic data structure;
calculate an average RSSI value, RSSI_{avg}, by performing an averaging analysis on stored RSSIₘ values in the historical data structure that are associated with the first data attribute; and
if RSSI_{avg} meets or exceeds the first predetermined RSSI data value, prepare transaction data received from the second mobile device for display on an interface of the first mobile device.
